(19) United States
(12) Patent Application Publication
(10) Pub. No.: US 2006/0283336 A1
(43) Pub. Date: Dec. 21, 2006

(54) Shower head with quick release flexible handpiece

(75) Inventors: Robert B. Eveleigh, Naples, FL (US); Stephen Ferrucci, Fishers, IN (US)

Correspondence Address: ICE MILLER LLP, ONE AMERICAN SQUARE, SUITE 3100, INDIANAPOLIS, IN, 46282-0200, US

(73) Assignee: Magarl, LLC, Indianapolis, IN (US)

(21) Appl. No.: 11/454,363

(22) Filed: Jun. 16, 2006

Related U.S. Application Data
(60) Provisional application No. 60/691,054, filed on Jun. 16, 2005.

(51) Int. Cl. A47J 37/12

(52) U.S. Cl. 99/403

(57) ABSTRACT

A quick disconnect shower head having a shower head housing operable to receive a quick disconnect fitting connected to a hose or other apparatus such that the apparatus is readily connected or disconnected to the shower head housing.

### CLAIM OF PRIORITY

This application claims priority to U.S. Provisional Patent Application No. 60/691,054 and entitled SHOWER HEAD WITH QUICK RELEASE FLEXIBLE HANDPIECE, filed Jun. 16, 2005.

### BACKGROUND

This invention relates to a system and apparatus for providing a fixed shower head with a hand held shower wand with a flexible extension.

In many healthcare or corrective facilities, the personal hygiene of patients or internees must be considered in light of safety for all individuals, ease of use, and economy and flexibility of physical facilities. In particular, facilities must be designed for a myriad of individuals, with each having different personal needs and risks. For example, both healthcare and corrective institutions often have individuals in their care with a high risk of suicide, individuals who are violent or uncooperative, and/or those lacking mobility. Each of these listed individuals presents a particular need in the design of hygiene facilities that makes it difficult to provide one particular room design to accommodate each type of individual or an individual having more than one of the above traits.

In particular, a single showering facility is often inadequate to meet the needs of the individuals having more than one of the above-identified needs. For example, an individual with violent and suicidal tendencies must be kept in surroundings carefully designed to eliminate elements that might be used to aid one in taking their own life. Such an individual could not have showering facilities outfitted with a shower head or knobs that might be used as an anchor point for a strangling implement. Additionally, a shower head designed for use by an individual in that state should not have a long pipe neck that might be easily broken from the wall or ceiling and used as a weapon. Conversely, some individuals lacking in mobility may need a shower head mounted on a long, flexible hose so that the shower head can be held in the hand and moved around the body for proper cleansing. Further, an uncooperative individual in this type of facility might also require the use of a hand-held shower head so that a nurse or other worker can attend to that individual's hygiene, even if the individual resists during the process.

Therefore, it is apparent that current shower designs do not address both of these problems. Certainly, there have been shower heads designed to prevent use as an anchor point, such as shower head part # 4577-60 available from Lawler Manufacturing Company, Inc. in Indianapolis, Ind. However, the very nature of designing a shower head to be used by individuals with suicidal tendencies has caused those in the art to eliminate any flexible hose or articulating feature that might be used for strangulation. Thus, the use of a shower head in a room or facility designed for individuals with suicidal tendencies can render that room or facility inadequate for housing or showering individuals with mobility problems. Therefore, individuals must be housed or showered in different facilities depending up on their needs, creating inefficient use of rooms or facilities that are designed only to meet one set of needs.

A shower head that could be used both as a hand-held unit for showering while eliminating any anchor points or features that may be used as strangling implements would be greatly desired. Such a shower head would help increase the efficiency of these facilities and reduce the facility overhead by allowing a single shower facility to be used by individuals having the disparate needs and characteristics identified above. Additionally, there are other applications in which it would be desirable to have a shower head with a detachable hose unit having a second shower head. For example, home use of a movable hand held shower nozzle would increase the ease of washing babies or children, and a quick means of disconnecting the second shower head would be advantageous.

### SUMMARY

The present invention relates to a quick-release shower head, and methods of its use. In one embodiment of the present invention, a quick-release shower head assembly comprises a shower head with a housing configured to receive a quick disconnect fitting, a quick disconnect fitting connected to a hose and operable to sealably engage the shower head. Additionally, the quick release shower head may comprise a gasket operable to secure a water-tight seal between the quick disconnect fitting and the shower head. Further, the quick release shower head may further be connected to a hand-held shower head on the end of the hose opposite the quick disconnect fitting. Alternatively, the shower head may be configured as a male component of a hydraulic quick coupling and the quick disconnect fitting may be configured as a female component of a hydraulic quick coupling. Regardless of the particular fitting used, the shower head optionally may have a cowling lacking anchor points.

Illustratively, another embodiment of the present invention comprises a shower head with one end operable to connect to a water source and a second end operable to emit water. The shower head housing further has a lip adjacent to the second end configured to receive a quick-disconnect fitting. Additionally, the lip may be configured to receive a quick disconnect fitting that circumscribes an opening through which water is emitted. Further, the quick lip may comprise a plurality of slots in the lip for receiving a plurality of posts associated with a quick disconnect fitting. Moreover, a quick disconnect fitting may comprise a collar sized to fit within the opening circumscribed by the lip and further comprise a plurality of posts sized and positioned so that the posts fit within the corresponding slots when the posts are aligned with the slots. Further, a quick disconnect fitting may be attached to a hose and hand-held showerhead, with the quick disconnect fitting comprising a collar sized to fit within the opening circumscribed by the lip, and the collar further having a plurality of spring-loaded posts with tapered ends. Additionally, the lip may be formed by a radial groove on an exterior surface of the second end of the shower head. Finally, there may be a quick disconnect fitting attached to a hose and hand-held shower head, with the quick disconnect fitting comprising a collar sized to fit over the exterior surface of the second end of the shower head and having a plurality of spring-loaded posts with tapered ends operable to engage a surface superior to the lip.

Illustratively, in yet another embodiment of the present invention, a quick release shower head and detachable fitting comprise a wall-mounted shower head housing having one end operable to connect to a water source and a second end operable to emit water, with the shower head housing having a lip for receiving a quick disconnect fitting at the second end, and a hose connected to a quick disconnect fitting configured to engage the lip to secure the hose to the shower head housing. Additionally the quick release shower head can comprise a gasket placed between the quick disconnect fitting and the surface of the second end of the shower head. The lip of the shower head may additionally contain at least one slot operable to receive a corresponding post from the quick disconnect fitting.

Another embodiment of the present invention comprises a detachable shower fitting with a first surface sized and shaped to correspond to the water-emitting end of a shower head, with the first surface having an opening through which water can pass when the first surface abuts the water-emitting end of the shower head; a quick disconnect operable to engage the shower head so that substantially all of the water from the shower head passes through the opening when the quick disconnect is engaging the shower head; and a second surface operable to attach to a hose. Further, the detachable shower fitting may further comprise a hand-held shower head attached to the hose. Additionally, the quick disconnect may comprise at least one spring-loaded post. Moreover, the quick disconnect may comprise at least one post corresponding to corresponding at least one slot present in the shower head. Finally, the quick disconnect may be operable to lockably engage a surface of the showerhead.

Another embodiment of the present invention relates to a method for reducing the likelihood of harm to an institutionalized individual while showering the individual. The method comprises the steps of providing a showering facility having a quick release shower head mounted on a wall, positioning the individual in the showering facility, attaching a quick disconnect and hose to the shower head, washing the individual with the hose extension, removing the hose extension, and taking the individual from the showering facility. The method can be performed so that each step discussed is performed in the order presented, or in varying order. Additionally, the method can be performed wherein the step of attaching a quick release hose extension and the step of removing the hose extension are performed in less than five minutes each. Further, the method can be performed wherein the step of attaching a quick release hose extension and the step of removing the hose extension are performed while the individual is in the showering facility. Finally, the method can be performed such that the step of attaching a quick release hose extension and the step of removing the hose extension are performed with one hand.

### BRIEF DESCRIPTION OF THE DRAWINGS

FIG. 1 shows a perspective view of a detachable hand-held shower head attached to a flexible hose having a quick disconnect according to an embodiment of the present invention.

FIG. 2A and 2B show a perspective view and plan view of a shower head according to one embodiment of the present invention FIG. 3A shows a perspective view of a shower head according to one embodiment of the present invention. FIGS. 3B and 3C show a perspective (FIG. 3B) and plan (FIG. 3C) view of a quick disconnect according to one embodiment of the present invention. FIG. 2D shows a gasket that may be used in this embodiment.

FIG. 4A shows a perspective view of a shower head according to one embodiment of the current invention. FIGS. 4B and 4C show and a perspective (FIG. 4B) and plan (FIG. 4C) view of a quick disconnect according to one embodiment of the present invention. FIG. 4D shows a gasket that may be used in this embodiment.

FIG. 5A shows a perspective view of a shower head according to one embodiment of the current invention. FIGS. 5B and 5C show a perspective (FIG. 5A) and plan (FIG. 5B) view of a quick disconnect according to an embodiment of the present invention. FIG. 5D shows a gasket that may be used in this embodiment.

FIG. 6A shows a perspective view of another shower head according to one embodiment of the current invention. FIG. 6B shows a quick disconnect suitable for use with the shower head of FIG. 6A.

FIG. 7A is similar to FIG. 6A except showing an alternative hydraulic quick coupling configuration. FIG. 7B is a cross-sectional view of a quick disconnect suitable for use with the shower head of FIG. 7A.

### DESCRIPTION

The invention relates to shower heads, and particularly to a quick disconnect shower head operable to receive a quick release fitting so that a hose and hand-held nozzle or other attachments may be readily attached or removed.

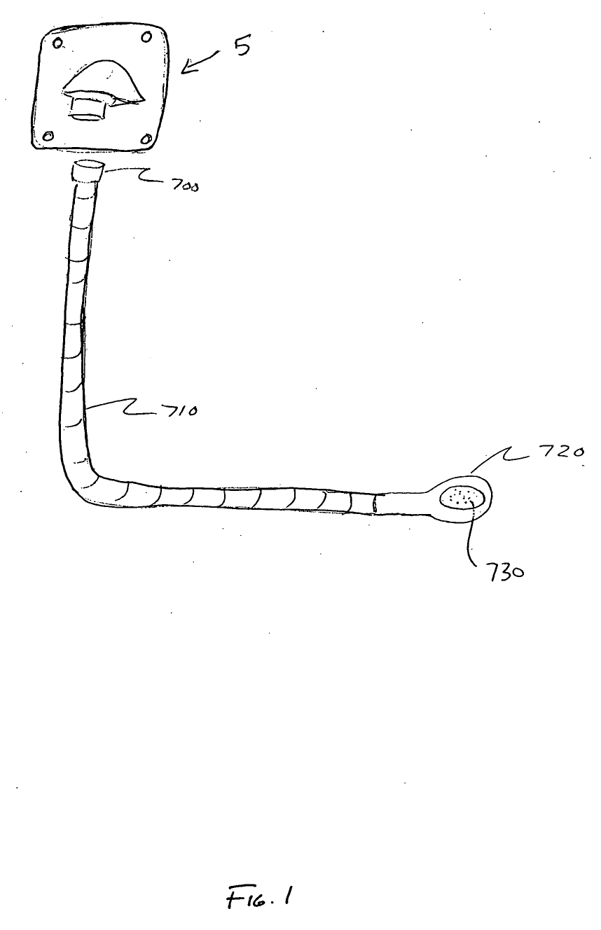

Referring to FIG. 1, an illustrative embodiment of a quick disconnect 700 attached by a hose 710 to a hand-held shower head 720. Hand-held shower head has a plurality of holes 730 through which a spray suitable for washing may be emitted. Quick disconnect 700 could be any of the previously described embodiments discussed herein, or any obvious configuration thereof. Additionally, it is understood that shower head 720 could be replaced by multiple other water-emitting items of other configurations, and that shower head 720 may be included on any of the embodiments discussed herein.

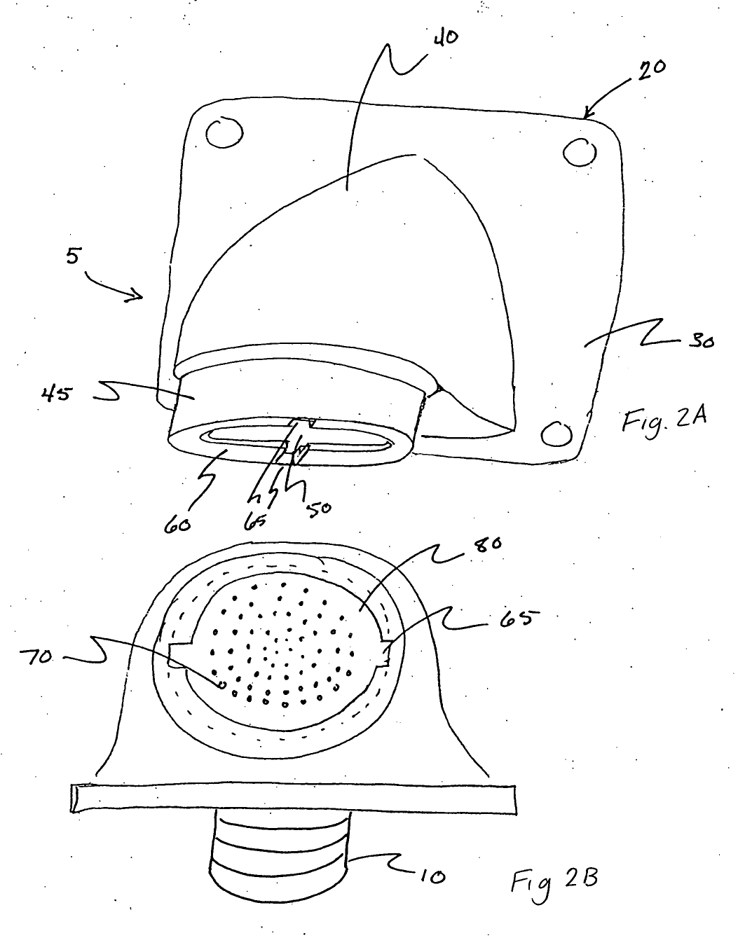

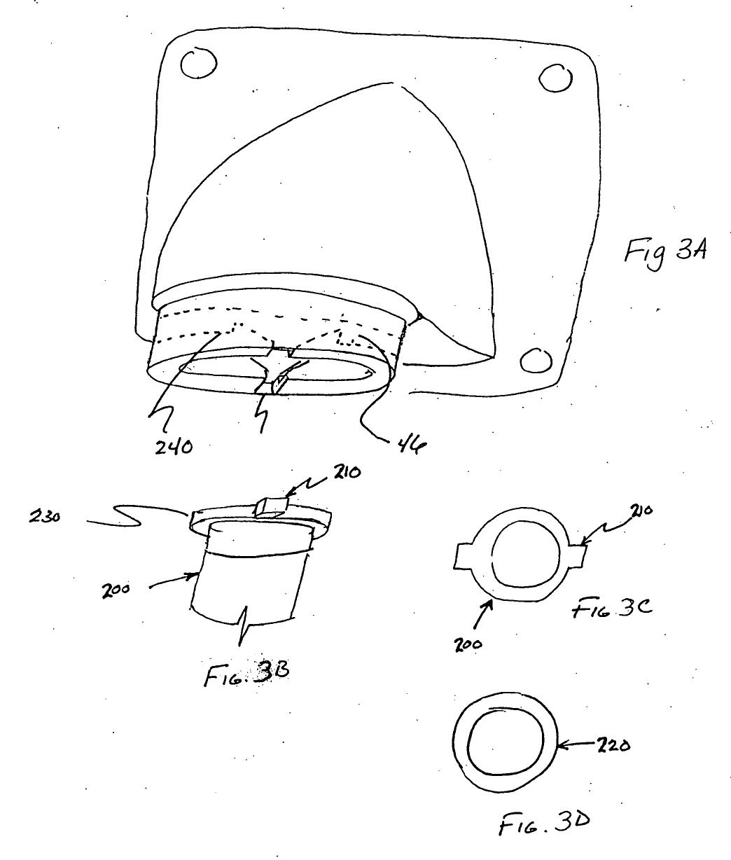

Referring now to FIGS. 2A-B, a shower head 5 according to one aspect of the present invention comprising an attachment point for a water source 10 connected to shower head housing 20. Shower head housing 20 comprises a mounting plate 30 that may be integrally molded to a cowling 40. The cowling 40 further has a removable spout cover 45 with an opening 50 for emitting water through the multiple holes 70 of shower stream plate 80. Opening 50 is circumscribed by a lip 60, illustratively having two notches 65 for receiving corresponding posts 210 of quick disconnect fitting 200 (as shown in FIG. 3). While two notches and two corresponding posts are shown, it is understood that any number of notches and corresponding posts may be used. As illustratively shown, multiple holes 70 are confined to an area that is smaller than opening 50 so that lip 60 does not interfere with the flow of water through holes 70. Further, in the illustrative embodiment, stream plate 80 is recessed from opening 50.

As shown in FIGS. 3A-D, quick disconnect fitting 200 is operable to be inserted into opening 50 of the shower head shown in FIGS. 3A-B when posts 210 are aligned with notches 65. After being inserted into opening 50, quick disconnect 50 is rotated such that posts 210 no longer align with notches 65, causing quick disconnect 200 to be secured to shower head 20. Illustratively, multiple posts and multiple corresponding slots can be provided. Optionally, a gasket 220 is placed between quick disconnect 200 and shower stream plate 80 so that gasket 220 is compressed when quick disconnect is inserted into opening 50. In one embodiment, gasket 220 may be provided as fixed to upper surface 230 of quick disconnect fitting 200. In another embodiment, gasket 220 may be provided fixed to shower stream plate 80 circumferentially located around multiple holes 20. In yet another embodiment, gasket 220 may be provided separately and merely placed between upper surface 230 and stream plate 80. Such placement helps quick disconnect fitting 200 to sealably engage shower stream plate 80 to reduce leakage between the fittings. Gasket 220 further adds pressure between the posts 210 and lip 60 to prevent quick disconnect 200 from inadvertently rotating and falling out of shower head 20. An o-ring or other seating surface may similarly be used instead of gasket 220. If an o-ring is used, upper surface 230 or stream pleate 80, or both, may be provided with a groove for proper seating of the o-ring.

FIG. 3A shows an alternate embodiment of the attachment means between the quick disconnect 200 and the shower head 20. As shown, the posts 210 of quick disconnect 200 can be inserted into elevating slot 46 and twisted until post 210 falls into place in the seat 240 of slot 46 quick disconnect 200. Thereafter, to remove quick disconnect 200 from shower head 20, quick disconnect 200 is pushed upward to unseat posts 210, and is twisted in the opposite direction from insertion. As shown, elevating slot 46 elevates quick disconnect fitting 200 when quick disconnect is rotated in either direction, allowing for secure attachment regardless of which direction quick disconnect 200 is rotated after insertion. It is understood that elevating slot may only spiral in one direction, requiring twisting in that one specific direction for seating. Illustratively, multiple posts 210 and corresponding seats 240 may be provided in arrangements so that quick disconnect seats when rotated 90 degrees. Further illustratively, multiple posts 210 and corresponding seats 240 may be provided in arrangements so that quick disconnect seats when rotated 180 degrees. Further illustratively, multiple posts 210 and corresponding seats 240 may be provided in arrangements so that quick disconnect seats when rotated 270 degrees. Further illustratively, multiple posts 210 and corresponding seats 240 may be provided in arrangements so that quick disconnect seats when rotated 360 degrees. Further illustratively, multiple posts 210 and corresponding seats 240 may be provided in an arrangement to allow seating when quick disconnect is rotated to any degree between 5 degrees and 355 degrees. Additionally, seats 240 are optional. If seats 240 are omitted, one must twist quick disconnect 200 until gasket 200 provides sufficient friction to hold quick disconnect in place.

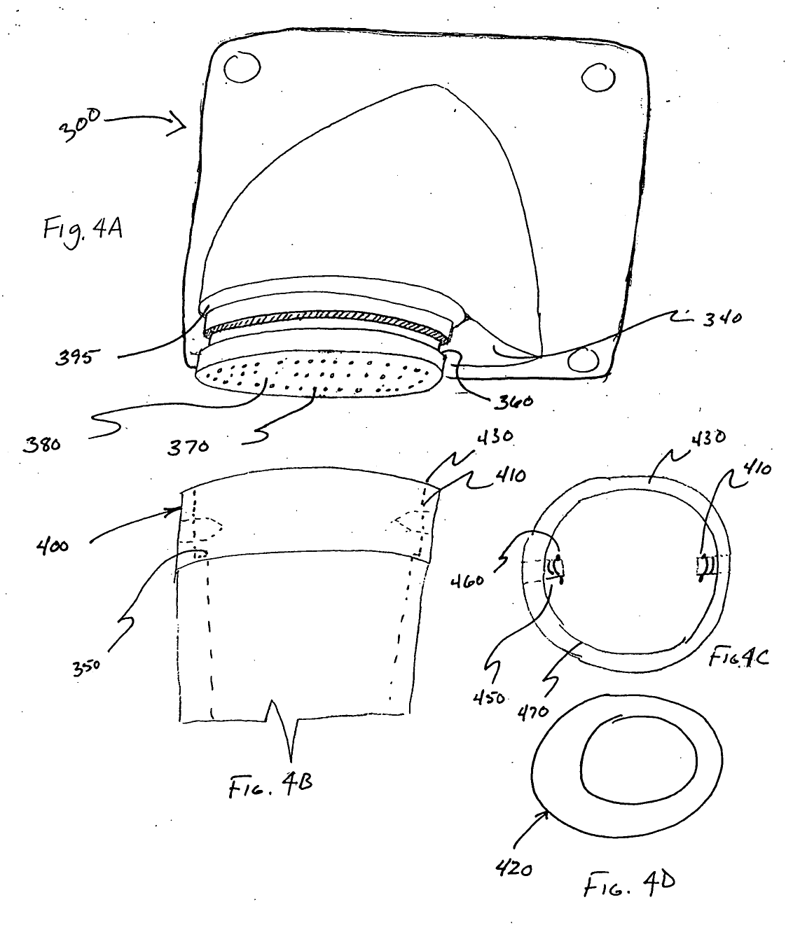

Referring now to FIGS. 4A-D, another embodiment of the present invention is shown, a shower head 300 comprising an attachment point for a water source (not shown) connected to shower head housing 320. Shower head housing 320 comprises mounting plate 330 optionally integrally molded to cowling 340. Cowling 340 further emits water through multiple holes 370 in shower stream plate 380, which provides a spray pattern suitable for showering, as known in the art. Shower stream plate 380 is situated such that a groove 360 is created for receiving retractable posts from a corresponding quick disconnect 400.

Quick disconnect 400, as shown in FIGS. 4B-C, comprises a collar 410 sized to slide over shower stream plate 380 and engage with the lower surface of cowling 340 of shower head 300, as shown in FIG. 4A-B. An optional gasket 440 having an inside and outside diameter similar to that of collar 410 can be positioned between upper surface 430 of collar 410 and lower cowling surface 395, so that gasket 440 is compressed between collar 410 and lower cowling surface 395 when quick disconnect 400 is engaged with shower head 300. Alternatively, gasket 420 may be provided between stream plate 380 and an optional shoulder 350 inside quick disconnect 400. Optionally, gasket 420 may be provided fixed to any of these surfaces. When properly engaged, gasket 440 provides a substantially water-tight seal, forcing all water emitted through holes 370 of shower face plate 380 to pass through quick disconnect 400 and on through any apparatus attached thereto. Quick disconnect 400 is secured to shower head 300 by retractable posts 410 engaging lip 360. While two retractable posts are shown, it is understood that any number of retractable posts may be used. Retractable posts 410 are spring-loaded to allow their movement away from the center of quick disconnect 400. Retractable tips can be spring-loaded by placing a spring 450 between inside wall 470 and pin nubs 460. The spring thereby exerts a pressure against pin nubs 460, pushing retractable posts 410 toward the center of the quick disconnect 400. Retractable posts 410 are prevented from being pushed out of quick disconnect 400 by a retainer pin or collar (not shown). Additionally, in the illustrative embodiment, the tips of retractable posts 410 are tapered. Further, sufficient downward force applied to quick disconnect 400 will allow retraction of the spring loaded retractable posts 410 and removal of quick disconnect 400 from shower head 300. However, the springs 450 loading the spring loaded posts can be selected to adjust the amount of pressure that must be applied to attach and remove quick disconnect from shower head 300. Thus, spring loaded posts 410 illustratively provide enough force to maintain quick disconnect 400 in place during routine use, but will retract if sufficient weight is placed on quick disconnect 400. Illustratively, spring loaded posts 410 may provide enough pressure to hold quick disconnect 400 on shower head 300 when sixty to eighty five pounds of pulling force is applied to quick disconnect 400, but do not provide enough pressure to hold quick disconnect 400 when over eighty-five pounds of pulling force is applied to quick disconnect 400. Further, it is understood that posts 410 need not be retractable, and notches similar to notches 65 may be provided on lip 360 so that the quick disconnect can be connected by twisting once posts 410 reach groove 360.

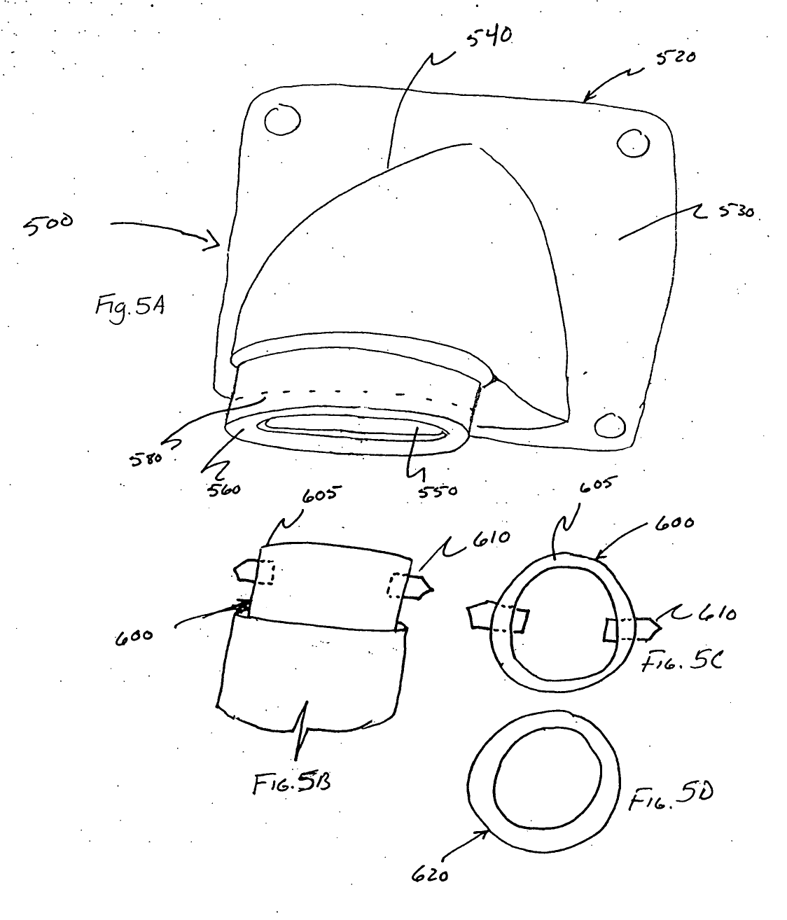

Referring now to FIGS. 5A-D, another embodiment of the present invention as shown, a shower head 500 comprising an attachment point for a water source 510 connected to shower head housing 520. Shower head housing 520 comprises mounting plate 530 illustratively integrally molded to cowling 540. Cowling 340 further has an opening 550 for emitting water through multiple holes (not shown) in shower stream plate 580. Opening 550 is circumscribed by a lip 560 for receiving corresponding retractable posts 610 of quick disconnect fitting 600 shown in FIGS. 5B-C. Shower stream plate is situated a sufficient distance from such lip 560 that retractable posts 610 will deploy from quick disconnect 600 to lock quick disconnect 600 to shower head.

Quick disconnect 600, as shown in FIGS. 5B-C, comprises a collar 610 sized to slide inside lip 560 and engage shower stream plate 580, illustratively between lip 560 and holes 570. An optional gasket, 620 can be placed between the top surface 605 of quick disconnect 600 and shower stream plate 580 to engage both surfaces and compress to provide a substantially water-tight seal. Alternatively, gasket 620 may be provided between lip 560 and an optional shoulder 640 on quick disconnect 600. As above, gasket 620 may be provided fixed to any of these surfaces or may be provided separately. When quick disconnect 600 is engageably connected to shower stream plate 580 with gasket 620 between them, substantially all water emitted through holes (not shown) of shower face plate 580 pass through quick disconnect 600 and on through any apparatus attached thereto. Quick disconnect 600 is secured to shower head 500 by retractable posts 610 engaging lip 560. Retractable posts 610 are spring-loaded to allow their movement away from the center of quick disconnect 600. Additionally, the tips of retractable posts 610 may be tapered to assist in forcing their retraction away from the from the center as quick disconnect 600 is pushed against shower head 500. Further, sufficient downward force applied to quick disconnect 600 will allow retraction of the spring loaded posts 610 and removal of quick disconnect 600 from shower head 500. However, the springs (not shown) loading spring loaded posts can be selected to adjust the amount of pressure that must be applied to attach and remove quick disconnect from shower head 500.

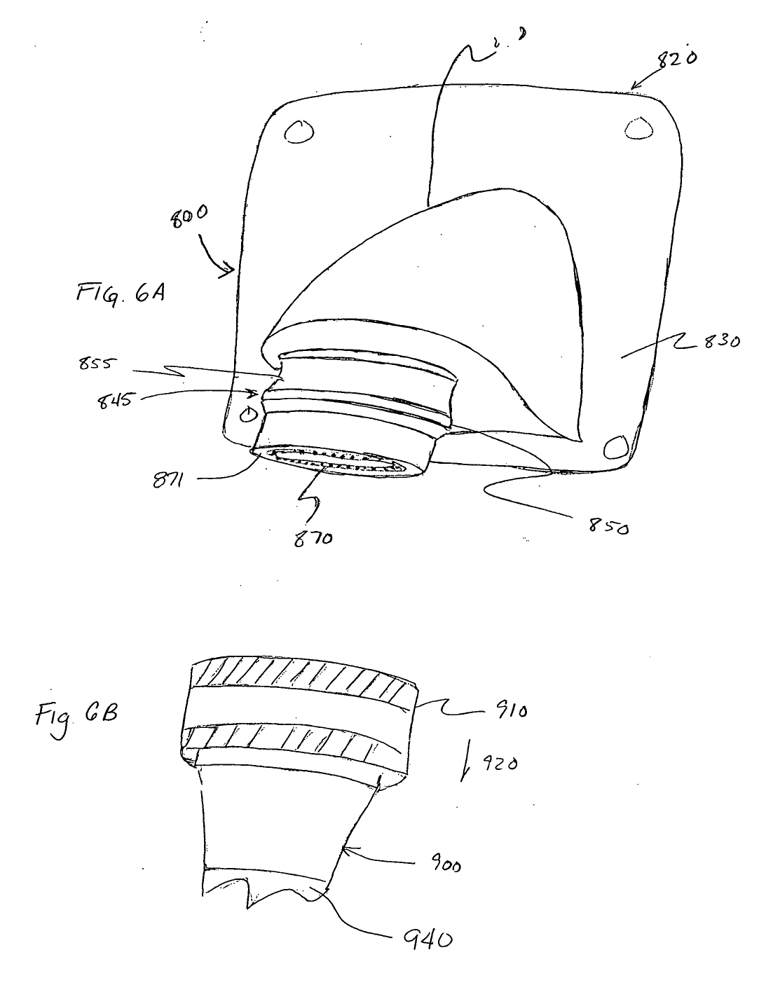

Referring now to FIGS. 6A and B, another embodiment of the present invention, a shower head 800 comprising an attachment point for a water source (not shown) connected to shower head housing 820. Shower head housing 820 comprises mounting plate 830 optionally integrally molded to cowling 840. Cowling 840 further has a contoured head member 845 for emitting water through multiple holes 870 in contoured head member 845. Contoured head member 845 is shaped and sized to receive quick disconnect fitting 900. It should be noted that contoured head member 845 and quick disconnect fitting are designed to mimic and operate as a male and female portion (respectively) of a hydraulic quick coupling. One suitable hydraulic quick coupling is the Parker 60 Series coupling sold by Parker-Hannifin (Cleveland, Ohio) and which is further described in U.S. Pat. No. 6,675,833 to Maldavs (the Parker coupling), herein incorporated by reference. One optional variation from the Parker coupling is shown, wherein no shut-off valve is present in the tip 871 of contoured head member 845. Therefore, regardless of whether quick disconnect 900 is attached to contoured head member 845, water will run through holes 870 to allow shower head 800 to operate as a normal shower.

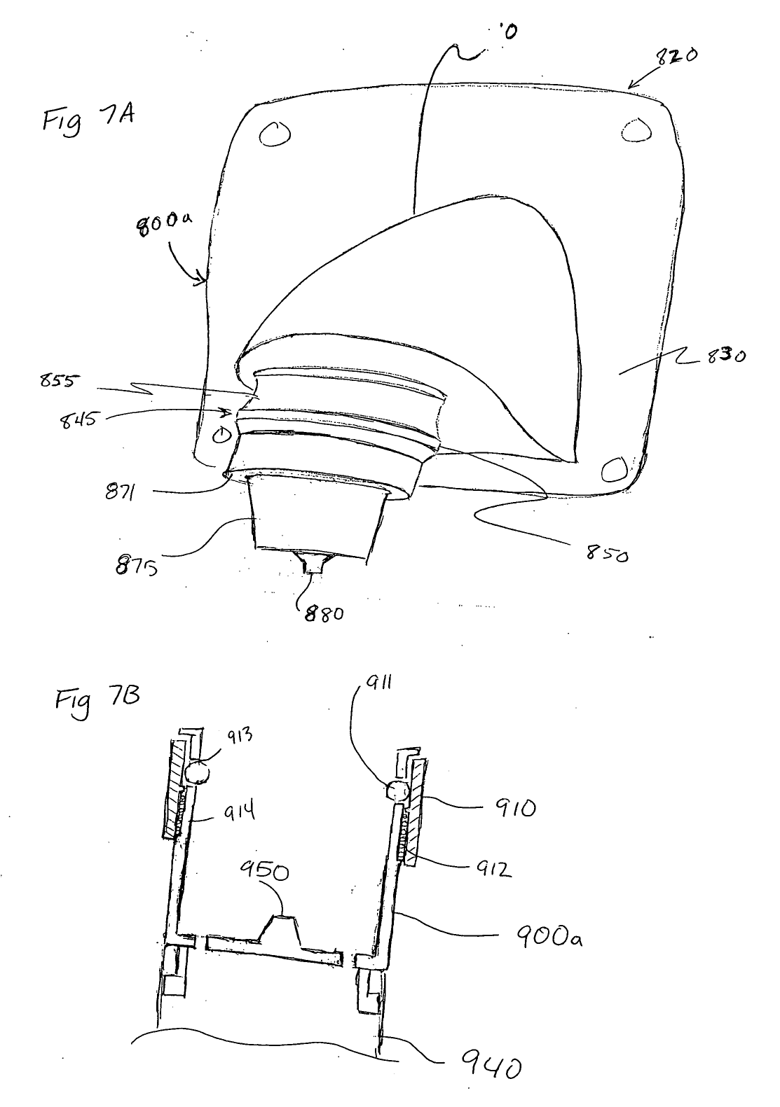

As seen in FIGS. 6B and 7B, spring-loaded collar 910 places inward pressure on ball bearings 911, which are housed in openings 913 in sleeve 914. In operation, spring-loaded collar 910 is pulled in a downward direction 920 to remove pressure from internal ball bearings 911. When pressure is released from ball bearings 911, quick disconnect 900 can be placed over ridge 850 of contoured head member 845. When spring-loaded collar 910 is released, spring 912 forces spring-loaded collar 910 upward and pressure is then once again placed on ball bearings 911, causing the ball bearings 911 to exert pressure on concave area 855. The pressure exerted on concave area 855 prevents quick disconnect 900 from being pulled from shower head 800 unless spring-loaded collar 910 is pulled down to release the pressure from the ball bearings 911. A hose 940 may be secured to quick disconnect 900, as discussed above.

Another optional embodiment is shown in FIGS. 7A and 7B. The embodiment shown in FIG. 7A is similar to that shown in FIG. 6A, except that a shut-off valve 875 is present at tip 871. When there is water pressure inside shower head 800a, pin 880 is forced downward, thereby sealing tip 871 and preventing water from exiting shower head 800. The quick connect 900a shown in FIG. 7B is similar to the quick connect 900 shown in FIG. 6B and has an extension 950 that bears on pin 880 of shut-off valve 875 when quick disconnect 900a is connected to shower head 800a. Extension 950 forces pin 880 upward, opening shut-off valve 875 and permitting water to flow through shower head 800a and quick disconnect 900a. Such shut-off valves are known in the art, for example in U.S. Pat. No. 6,675,833, already incorporated by references. The embodiment shown in FIGS. 7A-B may be well suited for use in prisons, where it may be desirable to prevent inmates form controlling water flow.

Other configurations for the shower heads are possible. For example, while in each of the examples the mounting plate is integrally molded to the housing, such is illustrative only. The mounting plate and housing may be two separate pieces that are affixed to each other, or the housing may extend through an opening in the mounting plate. Other embodiments for the shower head and quick disconnect are within the scope of this invention, and those of ordinary skill in the art will appreciate that there are several obvious variations of a quick disconnect shower head assembly.

1. A quick-release shower head assembly comprising:
a shower head having a housing having a cowling shaped and configured to lack anchoring points, and configured to receive a quick disconnect fitting; and
a quick disconnect fitting connected to a hose, said quick disconnect operable to sealably engage the shower head.

2. The quick release shower head of claim 1 further comprising a gasket configured to secure a water-tight seal between the quick disconnect fitting and the shower head.

3. The quick release shower head of claim 1 wherein said quick disconnect fitting is connected to a first end of said hose, said hose is further connected to a hand-held shower head on a second end opposite said first end.

4. The quick release shower head of claim 1 wherein the shower head is configured as a male component of a hydraulic quick coupling and the quick disconnect fitting is configured as a female component of a hydraulic quick coupling, said male component shaped to preclude the use of the shower head as an anchor point by which a substantially rope-shaped item could be anchored.

5. The quick release shower head of claim 1 further comprising a quick disconnect fitting attached to a hose and hand-held shower head, the quick disconnect fitting comprising a collar sized to fit over the exterior surface of the second end of the shower head and having a plurality of spring-loaded posts with tapered ends operable to engage a surface superior to the lip.

6. The quick-release shower head of claim 1 wherein the shower head and quick disconnect fitting are configured to operate as male and female portions of a hydraulic quick coupling.

7. The quick release shower head of claim 1 wherein the shower head comprises a cowling lacking anchor points.

8. The shower head of claim 1 wherein the shower head has a surface having a plurality of holes formed therein for emitting water when in use, the surface positioned such that water passes through the plurality of holes and into the quick disconnect fitting when the quick disconnect fitting is sealably engaging the shower head and water is flowing through the shower head.

9. The shower head of claim 14 wherein the surface having a plurality of holes provides a spray pattern suitable for showering.

10. A quick-release shower head and detachable fitting comprising:
a wall-mounted shower head housing having one end connectable to a water source and a second end operable to emit water;
said shower head housing having a lip for receiving a quick disconnect fitting at the second end; and
a hose connected to a quick disconnect fitting and another water-emitting apparatus, said quick disconnect fitting configured to engage the lip to secure said hose to said shower head housing.

11. The quick release shower head of claim 16 further comprising a gasket placed between the quick disconnect fitting and a surface of the second end, operable to secure a water-tight seal between the disconnect fitting and the shower head.

12. The quick release shower head of claim 16 wherein said lip further contains at least one slot operable to receive a corresponding post from the quick disconnect fitting.

13. A method for reducing the likelihood of harm to an institutionalized individual when showering the original, comprising the steps of:
a. providing a showering facility having a shower head shaped to prevent the presents of undercuts or anchor points on its exterior, and further comprising a quick release, said shower head mounted on a wall;
b. positioning the individual in the showering facility;
C. attaching a quick release hose extension to the shower head;
d. washing the individual with the hose extension;
e. removing the hose extension; and
f. taking the individual from the showering facility.

14. The method of claim 13 wherein steps b through f are performed in order.

15. The method of claim 13 wherein step of attaching a quick release hose extension to the shower head and the step of removing the hose extension are performed within five minutes of washing the individual with the hose extension.

16. The method of claim 13 wherein step of attaching a quick release hose extension to the shower head and the step of removing the hose extension are performed while the individual is in the showering facility.

17. The method of claim 13 wherein the attaching and removing steps are performed with one hand.
